(19) United States
(12) Patent Application Publication
(10) Pub. No.: US 2022/0391870 A1
(43) Pub. Date: Dec. 8, 2022

(54) SYSTEM AND METHOD FOR EXCHANGING PAYMENT DATA BETWEEN A CASH REGISTER AND A DEVICE FOR ACQUIRING ELECTRONIC PAYMENTS

(71) Applicant: BANKS AND ACQUIRERS INTERNATIONAL HOLDING, Paris (FR)

(72) Inventors: David NACCACHE, Paris (FR); Pavel POLECHTCHOUCK, Puteau (FR); Elena TRICHINA, Aix en Provence (FR)

(21) Appl. No.: 17/621,356

(22) PCT Filed: Jun. 22, 2020
(86) PCT No.: PCT/FR2020/051078

§ 371 Date: Aug. 15, 2022

(30) Foreign Application Priority Data
Jun. 25, 2019 (FR) FR1906851

(51) Int. Cl. G06Q 20/20

(52) U.S. Cl. CPC G06Q 20/204; G06Q 20/202

(57) ABSTRACT

A payment system including an electronic cash register associated with a physical point of sale of a merchant; and a payment acquisition device for advantageously cooperating with a payment issuing device of a client via a first link. Such a payment acquisition device transmits payment transaction messages (MSGT) to a bank server via a second link in order to implement electronic payment transactions. The payment acquisition device is configured to include a mechanism for capturing a view of any invoice issued by an electronic cash register, and the processing unit of such a payment acquisition device is configured to trigger the capture of at least one digital representation of the invoice and to automatically detect and determine therefrom the payment amount of the relevant financial transaction.

### FIELD OF THE INVENTION

This invention relates to the field of electronic payment transactions in a physical point of sale. More precisely, the invention aims to simplify the transfer of information characterising a payment, i.e. for example the amount of said payment, determined from a client invoice printed by an electronic cash register, to a payment acquisition device, such as a smart card reader. Such an Electronic Cash Register is often referred to by its acronym ECR and the Payment Acquisition Device by its acronym PAD.

### BACKGROUND OF THE INVENTION

Such a transfer of information is often required to perform a payment transaction when a client uses their Personal Issuing Device, referred to by its acronym PID. Such a personal issuing device generally consists of a smart card. Electronic cash registers and payment acquisition devices are generally made by different manufacturers. The link between a payment acquisition device and an electronic cash register is therefore based on the operation of specific communication protocols, whose standardisation requires joint efforts by said manufacturers concerned. Such efforts or compromises are not always possible or easy considering the large variety of payment acquisition devices and electronic cash registers available on the market.

For a very large majority of payment transactions using a payment acquisition device, a merchant must therefore type or enter manually, on a keypad of their payment acquisition device, the amount printed on an invoice issued by their electronic cash register for their client. Such an operation is tedious and generally slows down the sales transaction, but also involves the risk of entry errors.

The invention proposes a method and a system for eliminating such manual entry of information concerning a payment during a payment transaction using a payment acquisition device. The invention is not limited to the known and frequently used electronic cash registers, but also applies to any more specific cash register, such as for example an electronic cash register fitted in a taxi meter.

In the remainder of the document, an “electronic cash register” (ECR) will designate any peripheral capable of printing or displaying, for example on a computer screen, a list of articles or services purchased or consumed, respectively associated with a price or with any other information characterising it, as well as a total amount, designating the total financial consideration for the acquisition or the consumption, to be debited from a client account if any, more generally, said amount of a payment transaction. An electronic cash register is a system designed to allow the sale of products in a point of sale. Electronic cash registers are especially suitable for the sale of retail articles. They minimise register errors, collect inventory data, and much more. An electronic cash register therefore generally processes a batch of goods, based on:

reading information contained on a product label, generally using a bar code or QR code scanner;

consulting a database listing the respective unit prices of articles associated with different predetermined product labels.

Each price, associated with a good of said batch, is added to the previous one in order to obtain a total cumulated price of all goods forming the batch purchased or consumed by the client.

An electronic cash register can also transmit inventory data to a sales and stock management system during each sale made. It can also trigger, i.e. generate the printout of an invoice intended for the client, listing all the articles purchased or consumed, associated respectively with their prices, tax information such as the rate and amount of value added tax for example, and indicate a total cumulated purchase amount. Note that in the remainder of the description, the terms “trigger” and “generate” are used indifferently.

As a general rule, an electronic cash register is associated with a fixed Point Of Sale (POS). An electronic cash register can therefore be considered as one of the units of a modern POS. Thus, in many situations, both terms can be used indifferently.

Similarly, a Payment Acquisition Device (PAD), within the meaning of the invention, designates any device capable of processing an electronic payment transaction such as, given as non-limiting examples, a portable smart card reader, a mobile card reader, a mobile tablet hosting a payment application. A payment issuing device or personal issuing device designates any client device that can be used to make an electronic payment transaction such as, given as non-limiting examples, a debit or credit card, a gift card, a mobile payment application installed on a smartphone, a tablet, etc.

According to the state of the art, in numerous payment situations when electronic payment cards or other payment instruments, such as mobile wallets, are used to make payments on a physical point of sale, a list of articles or services purchased or consumed, associated with their respective prices, and a total amount to be paid are printed by an electronic cash register on a client invoice. As variant or as a complement, such an invoice can be displayed on the screen of an electronic cash register. Such an invoice, whether displayed graphically on screen or physically printed, generally includes other information concerning the transaction, such as for example one or more taxes, the transaction date and time, a transaction identifier, the name of said point of sale, for example the name of a store or restaurant, the address of said point of sale, etc. When the client chooses to pay their purchase with a personal issuing device (PID), such as a debit or credit card, the person operating said point of sale, more simply the merchant, must use a payment acquisition device, in this case and generally a smart card reader, to make the payment transaction. Depending on the configuration of the point of sale, said payment acquisition device may be fixed, portable or mobile, connected by wire or wireless to an electronic cash register installed on said point of sale. In some cases, several payment acquisition devices can be associated with the same point of sale. Generally, to make a payment transaction, the relevant payment information, such as the total amount to be paid, must be transmitted from the electronic cash register to the payment acquisition device. A client then uses their smart card and a standard authentication method, for example based on a personal identification number (PIN) code, is implement to make the electronic payment for the goods or services consumed.

As already mentioned, the large variety of electronic cash registers and payment acquisition devices available on the market does not generally allow automatic transfer of the transaction amount from the electronic cash register to the payment acquisition device. Said transaction amount, previously indicated on an invoice, printed and/or displayed on a screen, must therefore be typed manually on the payment acquisition device by the merchant or the person responsible for cashing the payment. In some situations, for example in bars, cafés or restaurants, a client does not need to go physically near an electronic cash register. The client is given a printed note or invoice by hand by a waiter. Said invoice indicates the articles purchased or consumed, their respective prices and the total amount to be paid. When the client chooses to pay with a debit or credit card, a waiter presents said client with a payment acquisition device, generally a wireless electronic device, for example a portable or mobile card reader. The waiter reads the printed invoice and copies the transaction amount manually, using a keypad or a touchscreen of the payment acquisition device. The client, if they think about it, must check the amount entered to make sure that it corresponds to the amount printed on the invoice, then enters a secret code or performs any other suitable authentication method to validate the transaction.

Copying this information manually, for example by a bar or restaurant waiter, or more generally a merchant, takes time and requires the mutual attention of said waiter and the client to make sure that the payment amount copied is correct. It involves the risk of making an error, especially during a stressful situation, for example if there are many clients in the same point of sale.

FIG. 1 shows a simplified illustration of a known payment system connecting a physical point of sale to a bank server to implement payment transactions. Such a system comprises an electronic cash register 10, a personal issuing device 30, consisting of a smart card, and a payment acquisition device 20. These three items are configured to interact with each other in a completely secure manner. According to the example of FIG. 1, said payment acquisition device 20 is also configured to communicate, via a secure link L2, such as for example the Internet, with a Payment Server 40 (hereinafter referred to as PS for short).

As shown on FIG. 1, during a purchase, said electronic cash register 10 prints and issues, before making a payment transaction as such, a client invoice B detailing the article(s) purchased or consumed, their respective prices and quantities, and a total amount due.

Such an invoice B is given by hand or simply displayed on a screen on the electronic cash register 10, so that a client C can read it.

Most sale transactions are currently performed using personal issuing devices, for example credit and/or debit cards 30. After being inserted in, or simply placed on, a suitable electronic device capable of communicating with it, such a personal issuing device can set up a communication, possibly contactless, to exchange information, or to implement processing operations for said electronic device, the latter possibly being a payment terminal or, in this case as shown on FIG. 1, a payment acquisition device 20. Such a communication between a payment acquisition device 20 and a personal issuing device 30 can be set up via a physical and direct link L1, for example using an electric terminal configured to interact mechanically and electrically with electric contact pads on the personal issuing device 30. A communication protocol, generally complying with standard ISO/IEC 7816, can be implemented by the two objects 20 and 30 to exchange information. As a variant, such a link L1 may be wireless or contactless, for example of radioelectric type, and consist in using a proximity communication protocol complying with standard ISO/IEC 14443, for example as provided for by the Near Field Communication (NFC) standard or the Radio Frequency Identification (RFID) standard, or any other equivalent solution.

A client C can therefore use a personal issuing device 30, typically their debit or credit card, which issues to the payment acquisition device 20, data, generally written in an electronic component, usually called a chip, or on a magnetic stripe.

A merchant M can also read the amount due indicated by the electronic cash register and printed on an invoice B then enter the transaction amount manually on a keypad of the payment acquisition device 20.

The client C can validate the transaction. The data, relating to said transaction as such, is then communicated by the payment acquisition device 20 to the payment server 40.

FIG. 2 shows a simplified view of a functional architecture of a known payment acquisition device 20. The respective functional architectures of the personal issuing device 30 and of the payment server 40 mentioned previously in relation with FIG. 1 are not detailed in this document, since these devices are not necessarily modified to implement the invention. We may nevertheless mention that they each have a processing unit, consisting of one or more microprocessors or microcontrollers, associated with data and program memories, as well as communication means or modems, terminal blocks and/or antennas, enabling them to communicate with the outside world via wired links (such as for example based on address and/or data buses, the Internet or an extranet) or wireless links, by implementing radiocommunication protocols, such as Wi-Fi (wireless communication protocols governed by the standards of the group IEEE 802.11), Bluetooth, ZigBee, Near Field Communication (NFC) or Radio Frequency Identification (RFID).

FIG. 2 therefore shows a simplified structure of a payment acquisition device (PAD) 20 according to the current state of the art. Such a payment acquisition device 20 can be a point of sale terminal or consist of a mobile, fixed or portable smart card reader, or any other electronic device capable of communicating with a personal issuing device (PID) 30 of a client C to make a payment transaction. A payment acquisition device 20 is a device which generally combines hardware and software components. It therefore generally comprises a processing unit 21, consisting of one or more microprocessors or microcontrollers, a program memory 23 and/or a data memory 24. A payment acquisition device 20 further comprises an input human-machine interface 22 allowing a human user C, M, to enter input information, such as for example a payment amount or a personal identification code. Such an input interface 22 may consist of an alphanumeric keypad or a touchscreen, or even a microphone, or more generally any means allowing a human to interact with the payment acquisition device to enter information or an instruction. A payment acquisition device 20 may further comprise an output human-machine interface 25, for example consisting of a screen or a loudspeaker, or more generally any means used to indicate the content of graphical or sound information to a human user C, M. When the input 22 and output 25 interfaces consist of a touchscreen, the touchscreen acts as both input and output device. Such an output human-machine interface 25 may further consist of or comprise a printer 26 to print a double receipt certifying the completeness of a payment transaction, the first ticket TM being intended for a merchant M and the second ticket TC being intended for a client C.

In addition, a known payment acquisition device 20 generally comprises communication means 27 for communicating with the outside world. Thus, to implement a proximity link L1 with a personal issuing device, such communication means 27 may consist of a communication module (terminal block) 272 of type ISO/IEC 7816 or a module 273 (antenna) of type ISO/IEC 14443. To implement a long distance or long range link L2, such communication means 27 may comprise a module 271 of modem or radio type, for example of type GSM/GPRS.

Lastly, a known payment acquisition device 20 generally comprises an internal electrical energy source 29 to supply the various components with the energy they need to operate. Such a source 29 may consist, for example, of a lithium battery or any other equivalent technology.

### SUMMARY OF THE INVENTION

This invention can remedy all or some of the disadvantages of the known solutions, in particular those induced by a merchant copying information manually, in other words, loss of time, mutual and tedious attention to be paid by said merchant and their client to make sure that the payment amount copied is correct. It proposes in fact a method and a system eliminating the copying or manual entry operations during payment operations, in particular when such operations are performed using portable or mobile payment acquisition devices, such as smart card readers. To do this, a payment acquisition device is adapted to automatically identify then capture on a client invoice the relevant payment information for the transaction concerned by said invoice. The digital representation or the image resulting from such capture is written in a data memory of the payment acquisition device. Said digital representation is processed to translate, into alphanumeric data, the amount of the payment printed on the invoice thus previously captured or digitised, said alphanumeric data then being transmitted to a payment unit or to a payment application installed on a payment acquisition device. At the same time, said alphanumeric data can be displayed on a screen of said payment acquisition device, so that the client can check the transaction amount thus automatically retrieved and validate said payment transaction using their payment card or any other personal issuing device in the usual way. The manual operations during the payment process, for example by a merchant, are thus reduced, which fluidifies the payment process and optimises customer satisfaction.

To this end, the invention provides in particular for a payment acquisition device comprising a processing unit, a data memory, a program memory, communication means to set up a first communication link with a payment server, an input human-machine interface configured to translate an action by a human user into input alphanumeric data that can be interpreted by said processing unit, an output human-machine interface configured to translate output alphanumeric data into a content perceptible by a human user, said processing unit being configured to generate a transaction message intended for the payment server, said transaction message encoding the data values describing respectively a payment amount, a merchant identifier and a client identifier, said processing unit also being configured to transmit said transaction message using the communication means. To avoid having to manually enter the payment amount of a transaction and therefore the disadvantages of the known solutions previously described, a payment acquisition device according to the invention comprises matrix capture means for capturing a view of an invoice graphically representing payment information, when said invoice is in the field of capture of said capture means, the latter producing a digital representation of said invoice. The processing unit of such a payment acquisition device according to the invention is also configured to determine, on the basis of the digital representation produced, the payment amount encoded in the transaction message.

To simplify the transaction and therefore authenticate a client wanting to make an electronic payment, the communication means of a payment acquisition device according to the invention can also be configured to set up a second communication link with a personal issuing device. In this case, the processing unit is also configured to implement a method for authenticating the holder of said personal issuing device by using jointly a personal identification code entered via the input human-machine interface and data exchanged via the second communication link with said personal issuing device, and to only transmit said transaction message to the payment server if the conditions required by said authentication method are met.

So that the client can in particular make sure that the payment amount determined by a payment acquisition device according to the invention is correct, the processing unit of said payment acquisition device can be configured to trigger an output of a content translating the payment amount determined from the digital representation.

According to a second object, the invention relates to a method implemented by the processing unit of a payment acquisition device according to the invention, and in particular a method for generating a transaction message for a payment acquisition device. Such a method comprises a step of generating a transaction message intended for a payment server, said transaction message encoding the data values describing respectively a payment amount, a merchant identifier and a client identifier, a step of triggering the transmission of said transaction message to said payment server using the communication means of said payment acquisition device. Such a method comprises a step, before the step of generating the transaction message, of triggering the capture of a view of an invoice when it is present in the capture field of the capture means of said payment acquisition device by said means and thereby producing and saving a digital representation of said invoice in the data memory of said payment acquisition device. Such a method comprises a new step of identifying and/or determining the payment amount from said digital representation, said step of generating the transaction message encoding said payment amount thus determined in order to create said transaction message.

So that the client can make sure that the payment amount determined is correct, such a method may comprise a step of triggering an output, via the output human-machine interface of the payment acquisition device, of a content generated to translate the payment amount determined from the digital representation of the invoice.

Advantageously, but not limited to, the step of identifying and/or determining the payment amount from the digital representation of an invoice may consist of an estimation performed by a convolutional neural network of the processing unit of a payment acquisition device according to the invention.

According to a third object, the invention further relates to a computer program product comprising program instructions which, when they are written in the program memory of a payment acquisition device according to the invention, and interpreted or executed by the processing unit of said device, trigger the implementation of a method also according to the invention.

According to a fourth object, the invention relates to a system comprising a payment acquisition device according to the invention, a payment server, an electronic cash register to produce an invoice that can be captured by the matrix capture means of said acquisition device.

Advantageously, but not limited to, such a system may further comprise a personal issuing device, when the payment acquisition device is configured to cooperate with such a personal issuing device.

### BRIEF DESCRIPTION OF THE DRAWINGS

Other features and advantages will appear more clearly on reading the description which follows, and referring to the attached drawings in which:

FIG. 1, already described, shows a simplified and known system for the management of a payment transaction from a point of sale up to the processing of said payment by a bank server;

FIG. 2, already described, shows a simplified view of a functional architecture of a known payment acquisition device;

FIG. 3 shows a simplified view of a functional architecture of a non-limiting example of a payment acquisition device according to the invention;

FIG. 4 shows a simplified view of a functional flowchart of a method implemented by a payment acquisition device according to the invention;

FIG. 5 shows a simplified system for the management of a payment transaction from a point of sale up to the processing of said payment by a bank server, said system being according to the invention.

### DETAILED DESCRIPTION OF THE INVENTION

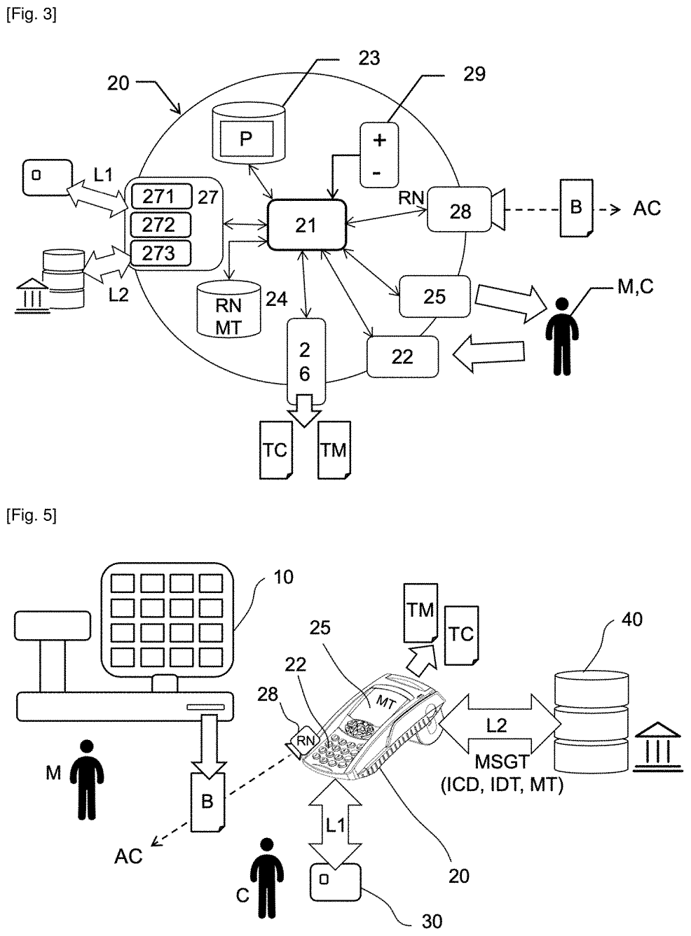

FIG. 3 is a diagrammatic representation of a payment acquisition device 20 adapted according to this invention to prevent any errors during the manual entry of a payment amount according to the usual techniques. According to the invention, such a payment acquisition device 20 is quite similar to that described previously in relation with FIG. 2. It therefore comprises a processing unit 21, consisting of one or more microprocessors or microcontrollers, a program memory 23 and/or a data memory 24. A payment acquisition device 20 according to the invention further comprises an input human-machine interface 22 allowing a human user C, M, to enter input information, such as for example a payment amount or a personal identification code. Such an input interface 22 may consist of an alphanumeric keypad or a touchscreen, or even a microphone, or more generally any means allowing a human to interact with the payment acquisition device 20 to enter information or an instruction. Such a payment acquisition device 20 may further comprise an output human-machine interface 25, for example consisting of a screen or a loudspeaker, or more generally any means used to indicate the content of graphical or sound information to a human user (for example a customer C, a merchant M). When the input 22 and output 25 interfaces consist of a touchscreen, the touchscreen acts as both input and output device. Such an output human-machine interface 25 may further consist of or comprise a printer 26 to print a double receipt certifying the completeness of a payment transaction, the first ticket TM being intended for a merchant M and the second ticket TC being intended for a customer C.

In addition, a payment acquisition device 20 according to the invention generally comprises communication means 27 for communicating with the outside world. Thus, to implement a proximity link L1 with a personal issuing device 30, such communication means 27 may consist of a communication module (terminal block) 272 of type ISO/IEC 7816 or a module 273 (antenna) of type ISO/IEC 14443. To implement a long distance or long range link L2, such communication means 27 may comprise a module 271 of modem or radio type, for example of type GSM/GPRS.

Advantageously, to improve its autonomy, a payment acquisition device 20 according to the invention may comprise an internal electrical energy source 29 to supply the various components with the energy they need to operate. Such a source 29 may consist, for example, of a lithium battery or any other equivalent technology.

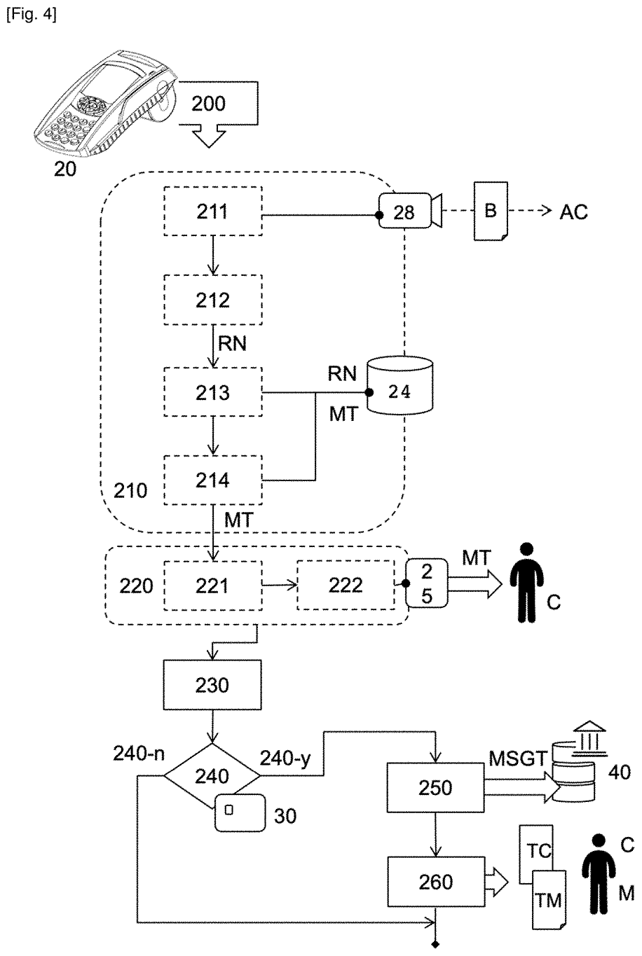

A payment acquisition device 20 according to the invention stands out in particular from the state of the art in that it further comprises means 28, for example consisting of a matrix sensor or a matrix camera, to digitise all or part of a view of an invoice B issued by an electronic cash register and thus produce a digital representation or image RN of the total or partial content of said invoice B. Such a digital representation RN can be written in the data memory 24 of the payment acquisition device 20 to be processed therein. The processing unit 21 can in fact be adapted according to the invention to trigger said capture and perform such processing operations using a suitable computer program P, whose program instructions are written in the program memory 23 of the payment acquisition device 20, and whose execution or interpretation by said processing unit 21 triggers the implementation of a method, an example of which is illustrated later in relation with FIG. 4.

To make it easier to capture or digitise an invoice B, a graphical display of a view of the invoice, when the capture means 28 are activated, can be triggered by the processing unit 21 and implemented by the output interface 25, when the latter consists of, or comprises, a computer screen for example. A merchant M or customer C using the payment acquisition device 20 can therefore correctly position the invoice B relative to the capture means 28, using this graphical information which guides the user's movements.

The invention also provides that said means 28 may comprise a plurality of matrix sensors. Thus, a plurality of digital representations or images RN, or even a video, can be obtained and/or saved in the data memory 24 of the payment acquisition device 20. Said plurality of capture or image data RN can describe the invoice B from different capture angles or different focalisations for easier future determination of the relevant payment amount MT.

The invention further provides that the processing unit 21 of the payment acquisition device 20 is adapted to trigger the processing of the digital representation(s) RN resulting from the captures of an invoice B. As non-limiting examples, such processing operations may consist of known image recognition methods or techniques to identify the useful payment information, said information possibly being associated with one or more keywords or, more generally, with determined graphical markers. Such processing operations, implemented by the processing unit 21 of a payment acquisition device 20 according to the invention, can be used to identify said relevant information, such as the payment amount in currencies, the transaction date, etc., and then translate such information into data, for example in the form of one or more alphanumeric strings.

In addition, the processing unit 21 is adapted to display on the output human-machine interface 25 of the payment acquisition device 20 the payment amount MT, automatically determined from the digital representation RN, so that the users M and C can ensure that the capture of the invoice B is correct. Lastly, like a known payment acquisition device 20, said processing unit 21 can transmit said payment information to an appropriate bank server 40, after confirming the identification or an authentication of the customer C and using a personal issuing device 30 belonging to said customer in the usual manner.

The invention provides that the processing unit 21 of a payment acquisition device 20 according to the information may further be adapted to save the payment information of each transaction in the data memory 24, in order to simplify any cash register or inventory check. Thus, the payment information for each payment made, and therefore acquired, by the device 20 of the merchant M is stored in the data memory 24. This payment information can therefore be easily extracted from the data memory 24 so that the merchant M can for example check the payments made by the various clients C on a given payment acquisition device 20. In addition, each of the various electronic components 22 to 29 thus cooperates with the processing unit 21 via power supply and/or control communication buses represented by arrows on FIG. 3. As a variant, some components could cooperate by coupling.

We can see that the invention does not require any structural or software modifications of the existing personal issuing devices (PID), point of sale (POS) terminals or electronic cash registers (ECR). Only the payment acquisition devices (PAD) according to the invention require a possible hardware modification by adding matrix capture means 28. The invention mainly relates to an adaptation of the operation of the processing unit 21 of such a payment acquisition device 20 by modifying or configuring a computer program P whose program instructions are loaded into its program memory 23.

In this respect, FIG. 4 shows a flowchart illustrating a method intended to adapt the operation of a payment acquisition device when said device is configured according to the invention, for example such as the device 20 described previously, as a preferred, non-limiting example, by FIG. 3. As shown on the flowchart, a method 200, implemented by the processing unit of a payment acquisition device according to the invention, comprises, like a method implemented by a known PAD, a step 230 of generating a transaction message MSGT intended for a payment server (referenced 40 on the figures), said transaction message MSGT encoding data values describing generally and respectively a payment amount MT, a merchant identifier IDM and a client or payor IDC (in other words the person making a payment for the benefit of the merchant). Such a method 200 further comprises a step 250 of triggering the transmission of said transaction message MSGT to said payment server 40 using the communication means, referenced 27 on FIGS. 2 and 3, of the payment acquisition device 20.

In a traditional and known manner, such a method 200 may further comprise a step 240 intended to only transmit said message MSGT if the procedure for authenticating the client C is met, when said client wants to make said payment using a personal issuing device (referenced 30 on FIGS. 2 and 3) such as a debit and/or credit bank card. In this case, such a step 240 may consist in using said personal issuing device 30, by sending it a challenge, generally consisting of an alphanumeric string, so that the personal issuing device 30 can compare said challenge with a reference word and return to the payment acquisition device 20 a result data item certifying conformity or non-conformity of said challenge with respect to said reference word. If the step 240 certifies an authentication failure or a non-conformity (situation represented by the link 240-n on FIG. 4), the transaction message MSGT is not transmitted to the bank server 40 and a subsequent step 260 of the method 200 consists in issuing, using output means 26 or 25 of the payment acquisition device 20, a graphical or printed double receipt, indicating that the transaction has failed, a ticket TM of said double receipt being intended for the merchant M and a second ticket TC being intended for the client C. When the step 240 certifies successful authentication or conformity of the challenge with respect to the reference word (situation represented by the link 240-y on FIG. 4), the transaction message MSGT can be transmitted, in step 250, to the payment server 40. Step 260 may then consist in issuing a double receipt TM, TC confirming respectively to the merchant M and to the client C that the financial transaction is complete.

According to the state of the art techniques, as mentioned previously, the transaction amount MT must be known in order to implement step 230. To do this, a method implemented by a known PAD comprises a step, not shown on FIG. 4 since deleted thanks to the invention, of querying the input human-machine interface 22 of the payment acquisition device. For a known PAD, in fact, said payment amount must be entered by the merchant generally using a keypad.

To avoid this manual entry, a method 200 according to the invention comprises a step or more generally a processing operation 210, before the step 230 of generating the transaction message MSGT, of triggering 211 the capture, using the matrix capture means 28 of said payment acquisition device 20, of all or part of a view of an invoice B when said invoice is present in the capture field AC of said matrix capture means 28, then producing 212 and saving 213 a digital representation RN of said invoice B in the data memory 24 of said payment acquisition device 20. The digital representation RN obtained is similar to an image composed of a matrix of pixels, each pixel describing one or more light intensities. Such a processing operation 210 of a method 200 according to the invention comprises a step 214 of identifying and determining, from said digital representation RN, the payment amount MT. To do this, said step 214 can implement, as non-limiting examples, known character recognition techniques to translate a part of the digital representation RN into a string of alphanumeric characters, or even into digital data translating the payment amount MT. To simplify such a step 214, the invoice B may comprise a marker, or more generally a determined graphic symbol, next to the payment amount. As a variant, the invention provides that such an amount can be displayed in clear in digital form or can be displayed in graphic form, for example encoded in the form of a bar code or QR code.

The invention further provides that the step of determining the payment amount can be more complex to meet application cases according to which, for example in bars, restaurants, taxis, etc., a client may need to add a tip to an amount to be paid for articles or services purchased and/or consumed. In such application cases, an invoice B issued to a client often comprises an additional line or space that the customer must complete manually, using a pen or via the adapted human-machine interface of an electronic cash register, to indicate a tip amount. Said client must generally mentally calculate the total amount to be paid as part of a payment transaction, when signing said invoice B. In this case, the processing operation 210 may consist in determining various graphic fields associated respectively with amounts to be added together, in a digital representation RN 212 resulting from the capture 211 of such an invoice B previously completed by the customer, then in decoding, storing and adding the digital values of the various graphic fields associated respectively with the amounts to be added together to obtain the total amount MT of the payment transactions to be implemented. Like a total amount printed directly, such a determination step 214 can be simplified if the invoice B comprises a marker, or more generally a determined graphic symbol, next to each amount that the processing unit 21 must add to obtain the total payment amount MT.

As a variant or complement, the invention provides that said processing unit 21 can be configured to comprise, for example, a convolutional neural network. In this case, the step 214 of determining a total payment amount MT may advantageously consist of an estimation made by such a convolutional neural network. According to such an advantageous embodiment, a method 200 according to the invention may comprise a prior step of learning by said convolutional neural network, not shown on FIG. 4, so that said convolutional neural network can identify the relevant fields in the digital representation RN and/or decipher some handwritten information present on an invoice B. Such assistance with step 214 by “artificial intelligence”, in this case according to this non-limiting example, using a convolutional neural network or any other equivalent technology, may allow combined use of different digital representations RN resulting from the simultaneous capture of said invoice B by matrix capture means 28 comprising a plurality of matrix sensors. Thus, a plurality of digital representations or images RN, or even a video, can be obtained and/or saved in the data memory 24 of the payment acquisition device. Said plurality of capture or image data RN can describe the invoice B from different capture angles or different focalisations for easier determination 214 of the relevant payment amount MT.

The step 214 may further consist in comparing the payment amount determined in step 214 with that written manually by the client on the captured invoice B, in order to display an error message if said amounts, one being determined and the other being written, are not equal. A method 200 according to the invention may thus comprise a step, not shown on FIG. 4, of triggering, via the output human-machine interface 25 of the payment acquisition device 20, a prompt asking the client C to choose one option out of those proposed, for example to cancel the transaction or continue the transaction after correcting the manual entry on the invoice B.

Irrespective of the embodiment of the processing operation 210 of a method 200 according to the invention, the step 230 of the method finally consists in using the payment amount MT thus determined to generate the transaction message MSGT.

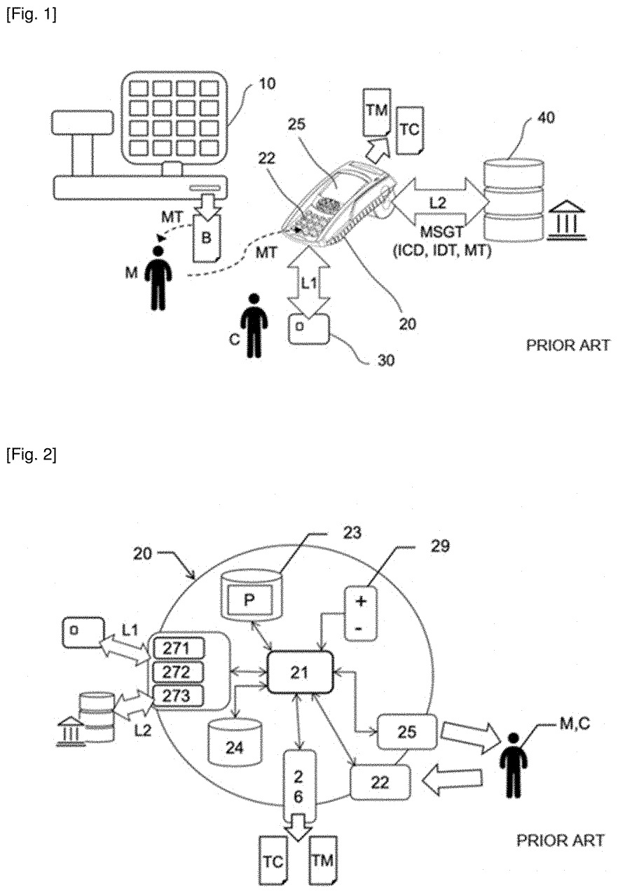

FIG. 5 describes a simplified payment system of a physical point of sale, similar to that described in relation with FIG. 1. However, the payment acquisition device 20 is configured according to the invention. In this respect, it comprises matrix capture means 28 for capturing a view of an invoice B issued by a conventional electronic cash register 10. The processing unit 21 of said payment acquisition device 20 is then configured to trigger the capture of at least one digital representation or image RN of said invoice B and to automatically detect and determine the payment amount MT of the financial transaction. Thus, a shown on FIG. 5, a system according to the invention comprises an electronic cash register 10 associated with a physical point of sale of a merchant M, a payment acquisition device 20 to cooperate, via a link L1, with a personal issuing device 30 of a client C. Said payment acquisition device 20 of the merchant is also configured to cooperate, via a link L2, with a payment server 40 of a bank, for example.

As shown on FIG. 5, after selling one or more articles to a client C, a merchant M operates an electronic cash register 10 which issues an invoice B printed on paper to said client C. Unlike the conventional system described in relation with FIG. 1 according to which said merchant M must re-enter manually the payment amount MT, printed on the invoice B, on the keypad or more generally via an input human-machine interface of a payment acquisition device 20, the latter being configured according to the invention, said merchant M positions said invoice B in the capture field AC of the matrix capture means 28 of said payment acquisition device 20. The processing unit of the payment acquisition device triggers the digitisation of a view of said invoice B, automatically determines the payment amount printed on said invoice B and prepares a message MSGT describing the transaction intended for the payment server 40, said message MSGT indicating the value of the payment amount MT thus automatically determined by the payment acquisition device 20. Before said message MSGT is transmitted to the payment server 40, the payment acquisition device 20 can display the payment amount MT determined automatically via its output human-machine interface 25. The client C can validate the transaction by reading the correctly determined payment amount and can accept the prompt to enter, via the input-human machine interface 22 of the payment acquisition device 20, their personal identification code associated with their personal issuing device 30 previously given to the merchant M, so that the latter can set up a link L1 between the two devices 20 and 30. The merchant M therefore no longer needs to enter a payment amount via the input human-machine interface 22 of the payment acquisition device 20, the latter automatically determining the transaction amount MT, thereby preventing any errors and slow cashing operations.

Lastly, the processing unit 21 of the payment acquisition device 20 can in particular save all the payment information of each transaction in the data memory 24. This allows, in particular, the merchant M to extract from the memory of the payment acquisition device 20, all the payment information of each transaction made on the payment device 20 by one or more clients (C), for example over a given period. Thus, for example, the merchant M can quickly and easily perform cash register or inventory checks. Note that the information stored may be limited to only the information which the merchant is authorised to store, in compliance with applicable regulations concerning bank transactions.

While this invention has been described referring to specific embodiments, in particular in relation with FIG. 5, said invention is not limited to the embodiments described. Consequently, the description and the drawings must be considered as illustrative and non-limiting examples.

1. Payment acquisition device (20) for a merchant (M) comprising a processing unit (21), a data memory (24) intended to store payment information for each payment acquired by the device (20), a program memory (23), communication means (27) to set up a first communication link (L2) with a payment server (40), an input human-machine interface (22) configured to translate an action by a human user (C, M) into input alphanumeric data that can be interpreted by said processing unit (21), an output human-machine interface (25) configured to translate output alphanumeric data into a content perceptible by a human user (C, M), said processing unit (21) being configured to generate a transaction message (MSGT) intended for the payment server (40), said transaction message (MSGT) encoding data values describing a payment amount (MT), said processing unit (21) also being configured to transmit said transaction message (MSGT) using the communication means (27), said payment acquisition device (20) being characterised in that it comprises matrix capture means (28) for capturing a view of an invoice (B) graphically representing payment information, when said invoice (B) is in the field of capture of said capture means (28), the latter (28) producing a digital representation (RN) of said invoice (B) and in that the processing unit (21) is also configured to determine, on the basis of the digital representation (RN) produced, the payment amount (MT) encoded in the transaction message (MSGT).

2. Payment acquisition device (20) according to the preceding claim, wherein the communication means (27) are also configured to set up a second communication link (L1) with a personal issuing device (30), and for which the processing unit (21) is also configured to implement a method for authenticating the holder (C) of said personal issuing device (30) by using jointly a personal identification code entered via the input human-machine interface (22) and data exchanged via the second communication link (L1) with said personal issuing device (30), and to only transmit said transaction message (MSGT) to the payment server (40) if the conditions required by said authentication method are met.

3. Payment acquisition device (20) according to the preceding claim, wherein the processing unit (21) is also configured to trigger an output of a content translating the payment amount (MT) determined from the digital representation (RN), via the output human-machine interface (25).

4. Payment acquisition device (20) according to any one of the preceding claims, wherein the memory unit (24) stores payment information of each transaction made by the payment acquisition device (20).

5. Method (200) for generating a transaction message for a payment acquisition device (20) for a merchant M, comprising:
a step (230) of generating a transaction message (MSGT) intended for a payment server (40), said transaction message (MSGT) encoding data values describing a payment amount (MT),
a step (250) of triggering the transmission of said transaction message (MSGT) to said payment server (40) using the communication means (27) of the payment acquisition device (20), characterised in that the payment amount (MT) is determined using the following steps:
a step, before the step (230) of generating the transaction message, of processing (210) and capturing (211) a representation of an invoice (B) using matrix capture means (28) of the payment acquisition device (20),
a step of producing (212) and saving (213) a digital representation (RN) of the invoice (B) in a data memory (24) of said payment acquisition device (20, and
a step (214) of identifying and /or determining the payment amount (MT) from the digital representation (RN).

6. Method according to the preceding claim, comprising a step (220) of triggering (222) an output, via the output human-machine interface (25) of the payment acquisition device (20), of a content (221) generated to translate the payment amount (MT) determined from the digital representation (RN).

7. Method (200) according to claim 5 or 6, wherein the step (214) of identifying and/or determining the payment amount (MT) from the digital representation (RN) of an invoice (B) consists of an estimation performed by a convolutional neural network of the processing unit (21) of the payment acquisition device (20).

8. Method (200) according to any one of claims 5 to 7, wherein the method (200) is implemented by a processing unit (21) of a payment acquisition device (20) according to any one of claims 1 to 5.

9. Computer program product (P) comprising program instructions which, when they are written in the program memory (23) of a payment acquisition device (20) according to one of claims 1 to 4, and interpreted or executed by the processing unit (21) of said device, trigger the implementation of a method according to any one of claims 5 to 8.

10. Payment acquisition device (20) according to any one of claims 1 to 4, wherein the program memory (23) comprises the instructions of a computer program product (P) according to claim 9.

11. System comprising a payment acquisition device (20) according to any one of claims 1 to 4 and 10, a payment server (40), an electronic cash register (10) to produce an invoice (B) of which a view can be captured by the matrix capture means (28) of said payment acquisition device (20), when said invoice (B) is in the field of capture (AC) of said matrix capture means (28).

12. System according to the preceding claim, comprising a personal issuing device (30) when the payment acquisition device (20) is according to claim 2.
